(19) United States
(12) Patent Application Publication
(10) Pub. No.: US 2013/0289790 A1
(43) Pub. Date: Oct. 31, 2013

(54) SMART GRID INTERACTING APPARATUS

(71) Applicant: Electronics and Telecommunications Research Institute, (US)

(72) Inventor: Wan Ki PARK, Daejeon (KR)

(73) Assignee: Electronics and Telecommunications Research Institute, Daejeon (KR)

(21) Appl. No.: 13/871,719

(22) Filed: Apr. 26, 2013

(30) Foreign Application Priority Data
Apr. 26, 2012 (KR) 10-2012-0043716

(51) Int. Cl. G06F 1/26

(52) U.S. Cl. CPC G06F 1/26
USPC 700/295

(57) ABSTRACT

A smart grid interacting apparatus may include an energy monitoring and management (EMM) client to provide a smart grid system interface function and a building energy management system (BEMS) function to collect and manage environmental data and operational data of an energy facility in a local building including an energy consumption equipment, an energy storage equipment, an electric vehicle charging station, and a new renewable energy production equipment, and an EMM remote control center to provide an integrated control function for the local building through communicate with the EMM client.

### CROSS-REFERENCE TO RELATED APPLICATION

This application claims the priority benefit of Korean Patent Application No. 10-2012-0043716, filed on Apr. 26, 2012, in the Korean Intellectual Property Office, the disclosure of which is incorporated herein by reference.

### BACKGROUND

1. Field of the Invention

Exemplary embodiments relate to a smart grid interacting apparatus for controlling energy consumption of a building efficiently by collecting and managing operational data of an energy facility and environmental data in the building through interaction between an energy monitoring and management (EMM) client and the energy facility based on a demand response.

2. Description of the Related Art

Energy saving technologies are being developed in an effort to promote an energy saving mode of individual electronic products. Currently, energy saving technologies are based on a demand response mechanism for operating a smart product in an energy saving mode at peak times and in a normal mode at off-peak times, based on demand response information, in particular, price information.

However, these passive energy saving technologies fail to respond to an abrupt increase in demand due to a transmission failure of price information in real time which makes it difficult to achieve high energy saving effects. To resolve this issue, a direct energy control technology or a dynamic energy control technology has been proposed to allow a consumer to control a function provided by a smart appliance including an ON/OFF function within an allowable range using a smart terminal. This may maximize a real-time response to a peak demand to deal with unexpected situations, such as, for example, an electrical outrage or a blackout, that is, a large-scale power failure, as well as to improve energy saving effects.

A smart grid corresponds to a form of an electric grid network using a digital technology to support an energy production and distribution system for optimum energy efficiency. Recently, a smart has been grid gaining globally, and many governments are adopting and enacting smart grid policies.

Demand response is a key smart grid application for motivating a consumer to reduce energy usage or offer incentives at times of higher wholesale electricity price or during periods of low operational systems reliability.

For efficient energy consumption of a building, a building energy management system (BEMS) has been developed and applied to monitor and control an operational status of a building energy facility and building environmental conditions using a sensor. As a solution to a shortage of energy experts, integrated energy monitoring and control based on a remote control center has been suggested to improve energy efficiency of a plurality of buildings.

Also, interactive energy and information management technologies between a power system and a consumer are being developed based on a combination of a power technology and an information and communication technology (ICT)-enabled intelligent technology in production, storage, consumption, and management of energy.

Accordingly, there is a need for a structure and method for operating a building energy facility based on an interactive smart grid model and a remote building energy management technology, to control energy consumption of a building efficiently.

### SUMMARY

An aspect of the present invention provides a smart grid interacting apparatus for providing a system environment for controlling energy consumption of a building efficiently by collecting and managing operational data of a building energy facility and building environmental data based on an interactive smart grid model in a building energy management system under the control of a remote energy control center, to respond to energy price changes effectively.

According to an aspect of the present invention, there is provided a smart grid interacting apparatus including an energy monitoring and management (EMM) client to provide a smart grid system interface function and a building energy management system (BEMS) function to collect and manage environmental data and operational data of an energy facility in a local building including an energy consumption equipment, an energy storage equipment, an electric vehicle charging station, and a new renewable energy production equipment, and an EMM remote control center to provide an integrated control function for the local building through communicate with the EMM client.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a network structure of a smart grid system and a building energy facility according to an embodiment of the present invention;

FIG. 2 is a diagram illustrating an example of a network structure of an energy monitoring and management (EMM) center having an integrated remote control function and buildings according to an embodiment of the present invention;

FIG. 3 is a diagram illustrating a structure of an EMM client for interacting with a smart grid system according to an embodiment of the present invention;

FIG. 4 is a diagram illustrating an EMM server platform of an EMM center according to an embodiment of the present invention; and

FIG. 5 is a diagram illustrating an energy optimization and maintenance (EOM) server platform of an EMM center according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

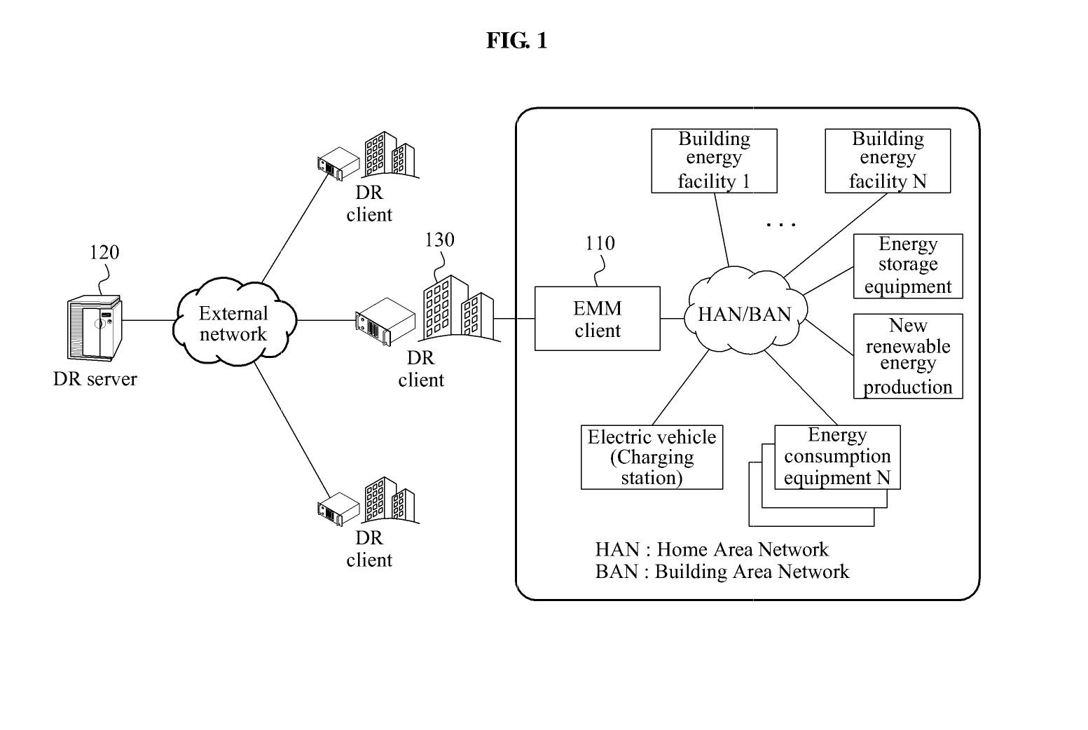

FIG. 1 is a diagram illustrating an example of a network structure of a smart grid system and a building energy facility according to an embodiment of the present invention.

Referring to FIG. 1, a building environment may include a smart grid component and an energy utility environment including an energy monitoring and management (EMM) client 110 to monitor and manage energy consumption of a building.

The EMM client 110 may be connected with a demand response (DR) server 120. The DR server 120 may be operated by an energy service provider to provide stability and reliability of a power system in a smart grid system. The DR server 120 may be connected with a DR client 130 via a network to transmit and receive a signal associated with an energy price and a DR strategy. The DR server 120 may allow an energy service provider to respond to an energy demand made by a customer through a network interface by determining a price strategy or by operating an energy production system.

Through the EMM client 110, the smart grid components may be connected with energy utilities deployed in a home area network (HAN) or building area network (BAN). That is, a smart grid technology may be introduced in the building.

The EMM client 110 may collect and control operational data of the energy utilities and building environmental data. For example, the EMM client 110 may be connected with an energy consumption equipment, a new renewable energy production equipment, an energy storage equipment, and an electric vehicle charging station to collect and control an energy consumption status, a new renewable energy production status, an energy storage status, and a charging/discharging status of an electric vehicle.

Also, the EMM client 110 may be connected with an integrated remote control center via an Internet connection to control energy consumption of a plurality of buildings efficiently through a remote control function.

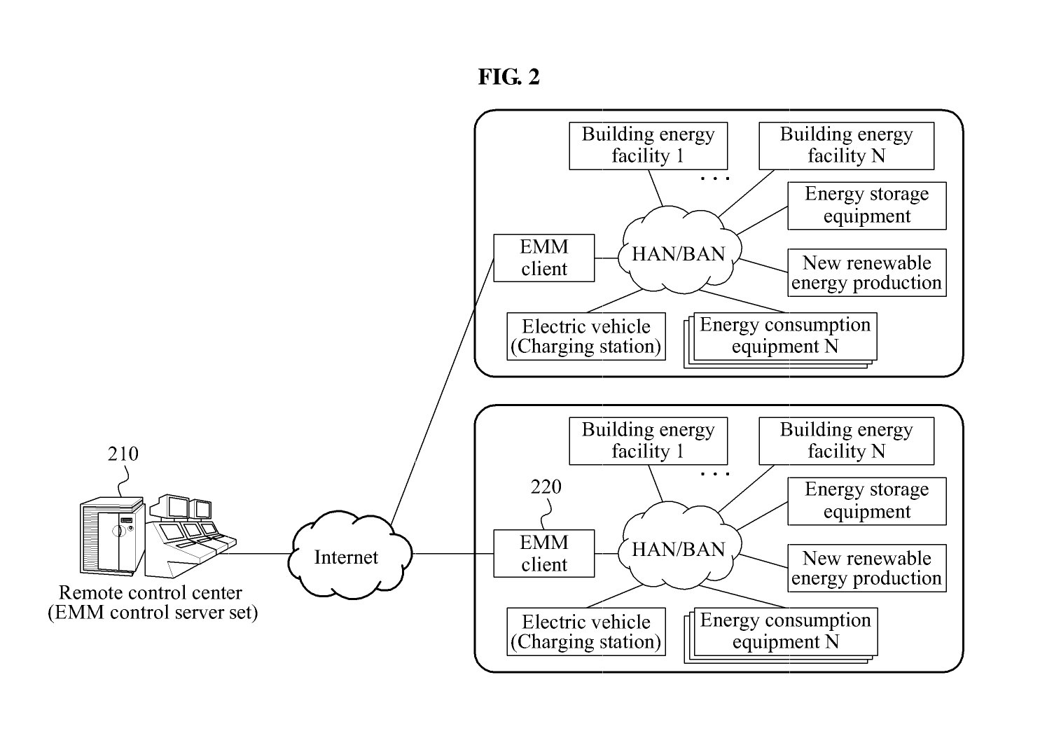

FIG. 2 is a diagram illustrating an example of a network structure of an EMM center having an integrated remote control function and buildings according to an embodiment of the present invention.

Referring to FIG. 2, the EMM center or EMM server set 210 may collect operational data of energy facilities and environmental data from a plurality of buildings. The EMM server set may be operated by an operator or an operating system of the EMM center. The EMM center 210 may be connected via an Internet with an EMM client 220 interacting with a smart grid system.

The EMM client 220 may collect and control operational data of energy utilities and environmental data, and may interact with a smart grid system. The EMM client 220 may include a DR system interacting unit, a local smart grid system interface function unit, an EMM client function unit for a BEMS function, and an EMM client communication function unit.

The DR system interacting unit may interact with a DR client of an energy service provider. The local smart grid system interface function unit may collect and manage operational data of an energy utility using an interface function for the energy utility. The EMM client function unit for a BEMS function may collect and control energy/environmental data to provide a BEMS function. The EMM client communication function unit or EMM center interacting unit may communicate with a server platform of the EMM center to transmit and receive operational data of the energy utility and environmental data, interaction data with the smart grid system, and control and management data of the energy facility and the smart grid system, under the control of the operator or operating system of the EMM center.

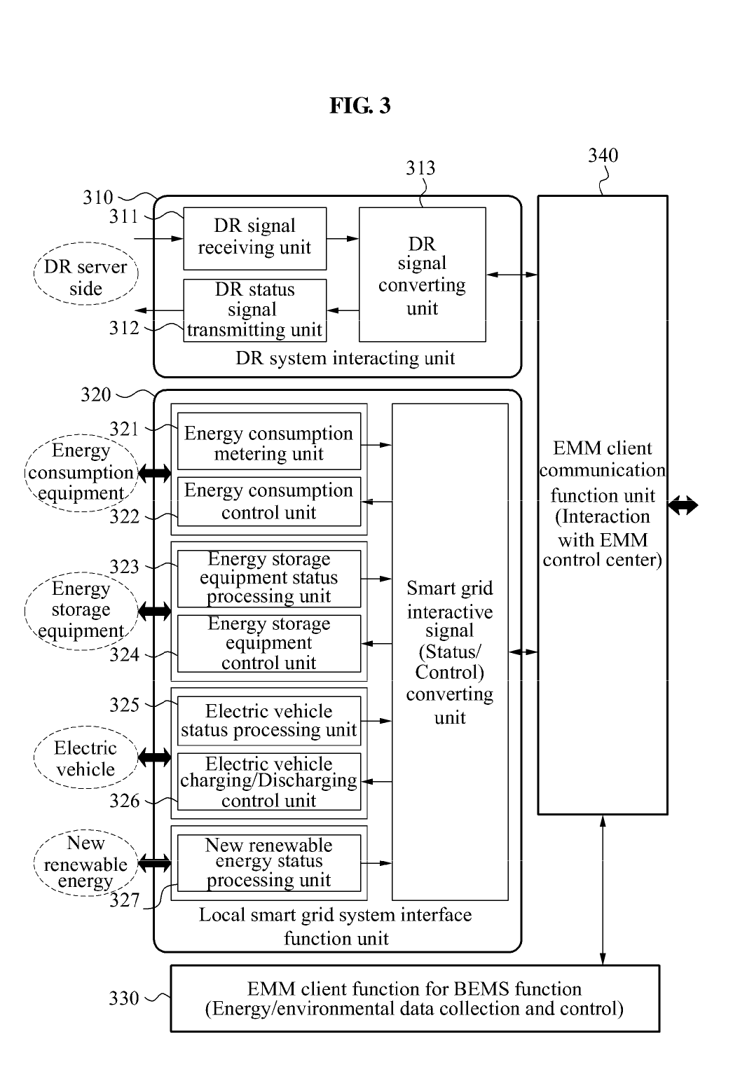

FIG. 3 is a diagram illustrating a structure of the EMM client for interacting with the smart grid system according to an embodiment of the present invention.

Referring to FIG. 3, the EMM client may include a DR system interacting unit 310, a local smart grid system interface function unit 320, an EMM client function unit for a BEMS function 330, and an EMM client communication function unit 340.

The DR system interacting unit 310 may interact with a DR system, and may include a DR signal receiving unit 311, a DR status signal transmitting unit 312, and a DR signal converting unit 313.

The DR signal receiving unit 311 may receive a DR signal from a DR client.

The DR status signal transmitting unit 312 may transmit a DR status signal including control data and status data of a power system in a building, in response to the DR signal.

The DR signal converting unit 313 may exchange data between the DR signal and the DR status signal.

The local smart grid system interface function unit 320 may provide an interface function for the smart grid system, and may include an energy consumption metering unit 321, an energy consumption control unit 322, an energy storage equipment status processing unit 323, an energy storage equipment control unit 324, an electric vehicle status processing unit 325, an electric vehicle charging/discharging control unit 326, a new renewable energy status processing unit 327, and a smart grid interactive signal (status/control) converting unit 328.

The energy consumption metering unit 321 and the energy consumption control unit 322 may provide an interface function for energy consumption equipment. The energy consumption metering unit 321 may meter energy consumption for each energy utility, and the energy consumption control unit 322 may control power consumption for each energy utility based on the metering result.

The energy storage equipment status processing unit 323 and the energy storage equipment control unit 324 may provide an interface function for energy storage equipment.

The electric vehicle status processing unit 325 and the electric vehicle charging/discharging control unit 326 may provide an interface function for an electric vehicle charging station.

The new renewable energy status processing unit 327 may provide an interface function for a new renewable energy production equipment.

The smart grid interactive signal (status/control) converting unit 328 may convert a smart grid interactive signal into a format for communication between the EMM client and a server of an EMM center.

The EMM client function unit for a BEMS function 330 may collect and control operational data of the energy utility, and may collect energy/environmental data.

The EMM client communication function unit or EMM center interacting unit 340 may communicate with a server platform of the EMM center to transmit and receive DR system interacting and management data of the DR system interacting unit 310, smart grid system operating and management data of the local smart grid system interface function unit 320, and energy facility operating and management data and energy/environmental data of the EMM client function unit for a BEMS function 330.

To implement an integrated remote control for buildings, the EMM center may include an EMM server platform for collection and management of building energy data, an energy optimization and maintenance (EOM) server platform for optimization and maintenance of building energy, and an energy security convergence (ESC) server platform for security. Here, the ESC server platform related to security is excluded from the present invention.

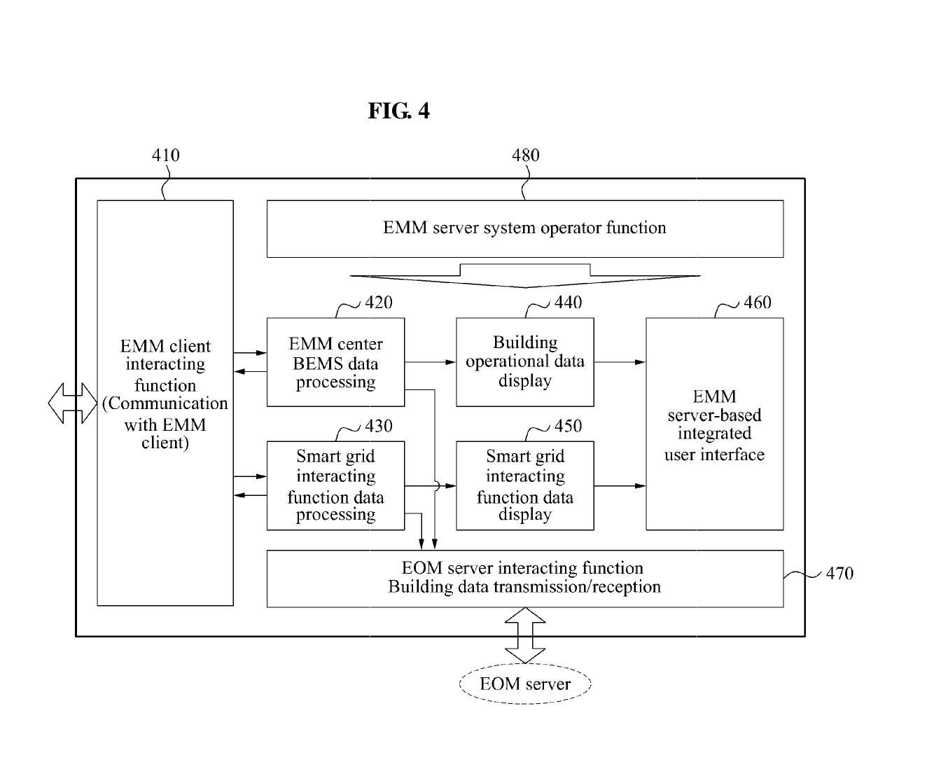

FIG. 4 is a diagram illustrating the EMM server platform of the EMM center according to an embodiment of the present invention.

Referring to FIG. 4, the EMM server platform of the EMM center may include an EMM client interacting function block 410, an EMM center BEMS data processing block 420, a smart grid interacting function data processing block 430, a building operational data display block 440, a smart grid interacting function data display block 450, an EMM server-based integrated user interface 460, an EOM server interacting function block 470, and an EMM server system operator function block 480.

The EMM client interacting function block or EMM client communication function block 410 may interact with an energy utility and a smart grid system through communication with an EMM client.

The EMM center BEMS data processing block 420 may process operational data and control data of an energy utility and environmental data, as conventionally performed by a BEMS of an EMM center.

The smart grid interacting function data processing block 430 may process interaction data with a local smart grid system.

The building operational data display block 440 may display operational data of an energy utility and environmental data.

The smart grid interacting function data display block 450 may display interaction data with a local smart grid system.

The EMM server-based integrated user interface 460 may provide a user interface function for data display.

The EOM server interacting function block or building data transmitting/receiving function block 470 may interact with an EMO server platform for operation optimization of an energy utility and building energy optimization based on a smart grid.

The EMM server system operator function block 480 may control and manage the entire operation of the EMM server platform.

The interaction data of the local smart grid system, the operational data of the energy utility, and the environmental data may be used for building energy optimization and maintenance by the EOM server platform of the EMM center.

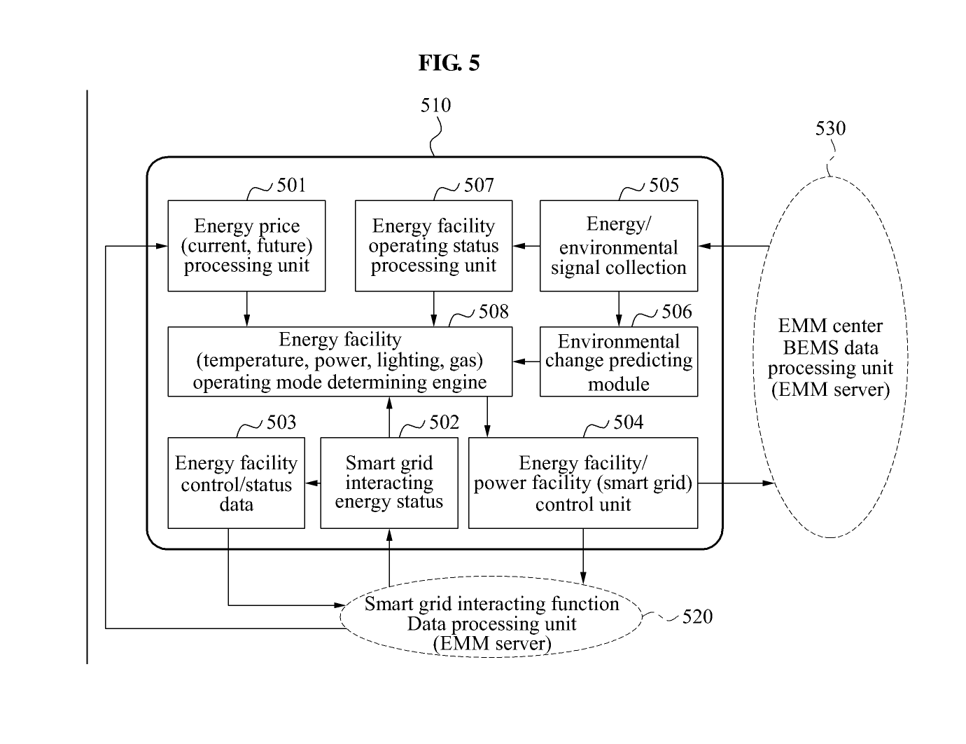

FIG. 5 is a diagram illustrating the EOM server platform of the EMM center according to an embodiment of the present invention.

Referring to FIG. 5, the EOM server platform 510 may interact with the EMM server platform of the EMM center. The EOM server platform 510 may be connected with a smart grid interacting function data processing unit 520 of the EMM server platform, and an EMM center BEMS data processing unit 530 of the EMM server platform.

The EOM server platform 510 may include an energy price (current, future) processing unit 501, a smart grid interacting energy status block 502, an energy facility control/status data block 503, an energy facility/power facility (smart grid) control unit 504, an energy/environmental signal collecting block 505, an environmental change predicting module 506, an energy facility operating status processing unit 507, and an energy facility (temperature, power, lighting, gas) operating mode determining engine 508.

The energy price (current, future) processing unit 501 may estimate a current energy price and a future energy price based on an energy price signal transmitted from a DR server of an energy service provider to an EMM client interacting with a smart grid.

The smart grid interacting energy status block 502 may manage status data of a local smart grid system.

The energy facility control/status data block 503 may manage control data and status data of an energy facility.

The energy facility/power facility (smart grid) control unit 504 may control an energy facility and a power facility in a building.

The energy/environmental signal collecting block 505 may collect operational data of an energy facility and environmental data.

The environmental change predicting module 506 may predict a building environmental change based on the collected data.

The energy facility operating status processing unit 507 may process an operating status of an energy facility.

The energy facility (temperature, power, lighting, gas) operating mode determining engine 508 may determine an operating mode of an energy facility by referring to an energy price, an operational status of the energy facility, a smart grid interacting energy status, and an environmental change.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to the exemplary embodiments of the present invention, the smart grid interacting apparatus may provide a system environment for controlling energy consumption of a building efficiently by collecting and managing operational data of a building energy facility and building environmental data based on an interactive smart grid model in a building energy management system under the control of a remote energy control center, to respond to energy price changes effectively.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A smart grid interacting apparatus comprising:
an energy monitoring and management (EMM) client to provide a smart grid system interface function and a building energy management system (BEMS) function to collect and manage environmental data and operational data of an energy facility in a local building including an energy consumption equipment, an energy storage equipment, an electric vehicle charging station, and a new renewable energy production equipment; and
an EMM remote control center to provide an integrated control function for the local building through communicate with the EMM client.

2. The apparatus of claim 1, wherein the EMM remote control center comprises:
an EMM server platform to collect and manage energy data of the local building and to monitor and display data about the smart grid system; and
an energy optimization and maintenance (EOM) server platform to conduct energy optimization and maintenance for the local building based on control data and status data associated with energy production, energy storage, energy consumption, and an electric vehicle, and a demand response (DR) signal transmitted and received with the smart grid system, as well as the operational data of the energy facility and the environmental data.

3. The apparatus of claim 1, wherein the EMM client comprises:
a DR system interacting unit to interact with a DR client of an energy service provider;
a local smart grid system interface function unit to provide a local smart grid system interface function to collect and manage data about the energy utility in the local building;
an EMM client function unit for a BEMS function to collect and control operational data of the energy facility and environmental data to provide a BEMS function; and
an EMM client communication function unit to communicate with the EMM remote control center to transmit and receive the operational data of the energy utility and the environmental data, interaction data with the local smart grid system, and control and management data of the energy facility and the local smart grid system, under the control of an operator or operating system of the EMM remote control center.

4. The apparatus of claim 3, wherein the DR system interacting unit comprises:
a DR signal receiving unit to receive a DR signal from the DR client;
a DR status signal transmitting unit to transmit a DR status signal including control data and status data of a power system in a building in response to the DR signal; and
a DR signal converting unit to exchange data between the DR signal and the DR status signal.

5. The apparatus of claim 3, wherein the local smart grid system interface function unit comprises:
an energy consumption metering unit and an energy consumption control unit to provide an interface function for the energy consumption equipment;
an energy storage equipment status processing unit and an energy storage equipment control unit to provide an interface function for the energy storage equipment;
an electric vehicle status processing unit and an electric vehicle charging/discharging control unit to provide an interface function for the electric vehicle charging station;
a new renewable energy status processing unit to provide an interface function for the new renewable energy production equipment; and
a smart grid interactive signal (status/control) converting unit to convert a smart grid system interactive signal into a format for communication between the EMM client and the EMM remote control center.

6. The apparatus of claim 2, wherein the EMM server platform comprises:
an EMM client interacting function block or EMM client communication function block to interact with the energy utility and the smart grid system through communication with the EMM client in the local building;
an EMM center BEMS data processing block to process the operational data and control data of the energy utility and the environmental data as an intrinsic BEMS function of the EMM remote control center;
a smart grid interacting function data processing block to process the interaction data with the local smart grid system;
a building operational data display block to display the operational data of the energy utility and the environmental data;
a smart grid interacting function data display block to display the interaction data with the local smart grid system;
an EMM server-based integrated user interface to provide a user interface function for data display;
an EOM server interacting function or building data transmitting/receiving function to interact with the EMO server platform for operation optimization of the energy facility and building energy optimization through interaction with the smart grid system; and
an EMM server system operator function block to control and manage the entire operation of the EMM server platform.

7. The apparatus of claim 2, wherein the EOM server platform is connected with the smart grid interacting function data processing block of the EMM server platform and the EMM center BEMS data processing block of the EMM server platform.

8. The apparatus of claim 2, wherein the EOM server platform comprises:
an energy price (current, future) processing unit to estimate a current energy price and a future energy price based on an energy price signal transmitted from a DR server of the energy service provider to the EMM client interacting with the local smart grid system;
a smart grid interacting energy status block to manage the status data of the local smart grid system;
an energy facility control/status data block to manage the control data and status data of the energy facility in the local building;
a building energy facility/power facility (smart grid) control unit to control the energy facility and the power facility in the local building;
a building energy/environmental signal collecting block to collect the operational data of the energy facility and the environmental data in the local building;
an environmental change predicting module to predict a building environmental change based on the collected data; and
a building energy facility operating status processing unit to process an operational status of the energy facility in the local building.
